(19) United States
(12) Patent Application Publication
(10) Pub. No.: US 2026/0230835 A1
(43) Pub. Date: Aug. 6, 2026

(54) ELECTRONIC DEVICE AND COMMUNICATION METHOD

(71) Applicant: Sony Group Corporation, Tokyo (JP)

(72) Inventors: Shuo WANG, Beijing (CN); Chen SUN, Beijing (CN)

(73) Assignee: Sony Group Corporation, Tokyo (JP)

(21) Appl. No.: 19/153,994

(22) PCT Filed: Mar. 11, 2024
(86) PCT No.: PCT/CN2024/080929

§ 371 Date: Aug. 6, 2025

(30) Foreign Application Priority Data
Mar. 15, 2023 (CN) 202310266687.2

(51) Int. Cl. H04W 16/14

(52) U.S. Cl. CPC H04W 16/14

(57) ABSTRACT

The present disclosure relates to an electronic device and a communication method. The electronic device comprises: processing circuitry configured to: acquire respective spectrum usage information of a plurality of wireless devices; and determine spectrum usage correlation among the plurality of wireless devices based on the respective spectrum usage information of the plurality of wireless devices, the spectrum usage correlation being used for allocating spectrum resources to the plurality of wireless devices.

### PRIORITY CLAIM

The present application claims the priority to the Chinese patent application No. 202310266687.2 entitled “ELECTRONIC DEVICE AND COMMUNICATION METHOD” and filed on Mar. 15, 2023, which is incorporated herein by reference in its entirety.

### TECHNICAL FIELD

The present disclosure relates to the field of communications, and more particularly, to dynamic spectrum sharing.

### BACKGROUND

In recent years, dynamic spectrum sharing technology has received attention. The technology refers to allowing different wireless devices to share the same frequency spectrum and dynamically allocating frequency spectrum resources to the wireless devices according to a certain mechanism. By utilizing the dynamic spectrum sharing technology, the use efficiency of the radio frequency spectrum can be effectively improved.

### SUMMARY

The following presents a simplified summary of the disclosure, in order to provide basic understanding of some aspects of the disclosure. However, it should be understood that this summary is not an exhaustive overview of the disclosure. It is not intended to identify critical or important elements of the disclosure or to delineate the scope of the disclosure. Its sole purpose is to present some concepts of the disclosure in a simplified form as a prelude to the more detailed description that is presented later.

In the dynamic spectrum sharing scheme known to the inventors of the present application, dynamic spectrum allocation for a single wireless device is considered with the purpose of interference reduction, but spectrum usage correlation among a plurality of wireless devices, such as time correlation, position correlation, frequency correlation, power correlation, beam correlation, etc., is not considered. In the present application, the spectrum usage correlation among a plurality of wireless devices is considered, the frequency spectrum resources are coordinated in a unified manner, and dynamic spectrum allocation and sharing is performed on the plurality of wireless devices, so that the efficiency of dynamic spectrum allocation can be improved and overhead for interference calculation can be reduced.

According to one aspect of the present disclosure, an electronic device is provided. The electronic device may comprise processing circuitry that may be configured to: acquire respective spectrum usage information of a plurality of wireless devices; and determine spectrum usage correlation among the plurality of wireless devices based on the respective spectrum usage information of the plurality of wireless devices, the spectrum usage correlation being used for allocating spectrum resources to the plurality of wireless devices.

According to another aspect of the present disclosure, there is provided a communication method. The method may comprise: acquiring respective spectrum usage information of a plurality of wireless devices; and determining spectrum usage correlation among the plurality of wireless devices based on the respective spectrum usage information of the plurality of wireless devices, the spectrum usage correlation being used for allocating spectrum resources to the plurality of wireless devices.

According to another aspect of the present disclosure, there is provided a computer-readable storage medium comprising executable instructions which, when executed by an information processing apparatus, cause the information processing apparatus to perform the communication method according to the present disclosure.

According to yet another aspect of the present disclosure, there is provided a computer program product comprising a computer program which, when executed by a processor, causes the processor to perform the communication method according to the present disclosure.

According to one or more embodiments of the present disclosure, the spectrum usage correlation among a plurality of wireless devices can be determined based on respective spectrum usage information of the plurality of wireless devices, and spectrum resources can be allocated to the plurality of wireless devices by utilizing the spectrum usage correlation, thereby improving the efficiency of the dynamic spectrum allocation and reducing the overhead for interference calculation.

### BRIEF DESCRIPTION OF THE DRAWINGS

The accompanying drawings, which are incorporated in and constitute a part of this specification, illustrate embodiments of the disclosure and together with the description, serve to explain the principles of the disclosure.

The present disclosure may be more clearly understood from the following detailed description taken in conjunction with the accompanying drawings, in which:

FIG. 1 is a block diagram illustrating an exemplary configuration of an electronic device for determining spectrum usage correlation for allocating spectrum resources to a plurality of wireless devices according to an embodiment of the present disclosure;

FIG. 2 is an exemplary flow diagram illustrating a communication method of determining spectrum usage correlation for allocating spectrum resources to a plurality of wireless devices according to an embodiment of the present disclosure;

FIG. 3 is a schematic diagram illustrating a system for allocating spectrum resources to a plurality of wireless devices based on spectrum blockchain according to an embodiment of the present disclosure;

FIG. 4 is a schematic diagram illustrating computation task offloading according to an embodiment of the disclosure;

FIG. 5 is a schematic diagram illustrating application of spectrum resource allocation to a CBRS system according to an embodiment of the present disclosure;

FIG. 6 is a schematic diagram illustrating application of spectrum resource allocation to a 3GPP system according to an embodiment of the present disclosure.

### DETAILED DESCRIPTION

Various exemplary embodiments of the present disclosure will now be described in detail with reference to the accompanying drawings. It should be noted that: relative arrangements of parts and steps, numerical expressions and numerical values set forth in these embodiments do not limit the scope of the present disclosure unless specifically stated otherwise.

Meanwhile, it should be understood that sizes of various portions shown in the drawings are not drawn to actual scale for the convenience of description.

The following description of at least one exemplary embodiment is merely illustrative in nature and is in no way intended to limit the disclosure, its application, or use.

Techniques, methods, and apparatuses known to one of ordinary skill in the related art may not be discussed in detail but are intended to be part of the specification where appropriate.

In all examples shown and discussed herein, any particular value should be construed as exemplary only and not as limiting. Thus, other examples of the exemplary embodiments may have different values.

It should be noted that: like reference numbers and letters refer to like items in the following figures, and thus, once an item is defined in one figure, it need not be discussed further in subsequent figures.

FIG. 1 is a block diagram illustrating an exemplary configuration of an electronic device 1000 according to an embodiment of the present disclosure. The electronic device 1000 may, for example, determine spectrum usage correlation for allocating spectrum resources to a plurality of wireless devices.

In some embodiments, the electronic device 1000 may include processing circuitry 1010. The processing circuitry 1010 of the electronic device 1000 provides various functions for the electronic device 1000. In some embodiments, the processing circuitry 1010 of the electronic device 1000 may be configured to perform a communication method for the electronic device 1000.

The processing circuitry 1010 may refer to various implementations of digital, analog, or mixed-signal (a combination of analog and digital) circuitry for performing functions in a computing system. The processing circuitry may include, for example, circuitry such as an Integrated Circuit (IC), an Application Specific Integrated Circuit (ASIC), portions or circuits of an individual processor core, an entire processor core, an individual processor, a programmable hardware device such as a Field Programmable Gate Array (FPGA), and/or a system including multiple processors.

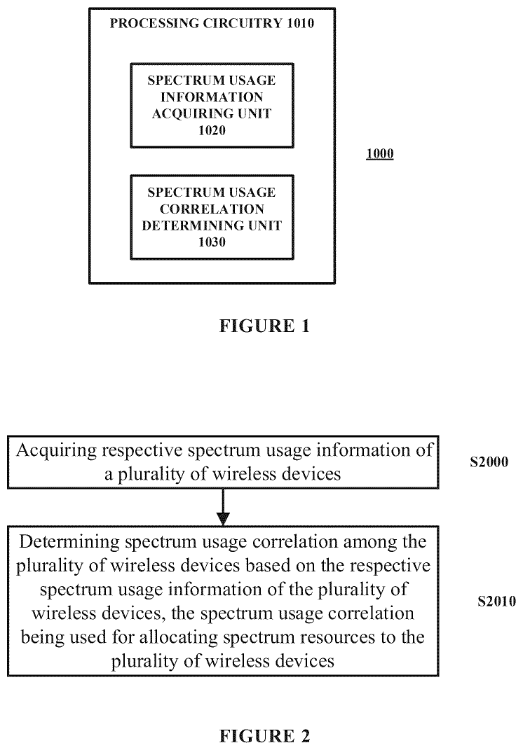

In some embodiments, the processing circuitry 1010 may include a spectrum usage information acquiring unit 1020 and a spectrum usage correlation determining unit 1030, configured to perform corresponding steps in a communication method illustrated in FIG. 2 described later.

In some embodiments, the electronic device 1000 may also include a memory (not shown). The memory of the electronic device 1000 may store information generated by the processing circuitry 1010, as well as program and data for operation of the electronic device 1010. The memory may be a volatile memory and/or non-volatile memory. For example, the memory may include, but is not limited to, Random Access Memory (RAM), Dynamic Random Access Memory (DRAM), Static Random Access Memory (SRAM), Read Only Memory (ROM), and flash memory.

In addition, the electronic device 1000 may be implemented at a chip level, or may also be implemented at a device level by including other external components. In some embodiments, the electronic device 1000 may be implemented as a complete machine and may also include multiple antennas.

It should be understood that, the above units are only logic modules divided according to specific functions implemented by the units, and are not used for limiting specific implementations. In actual implementation, the above units may be implemented as independent physical entities, or may also be implemented by a single entity (for example, a processor (CPU or DSP, etc.), an integrated circuit, etc.).

FIG. 2 is an exemplary flow diagram illustrating a communication method of determining spectrum usage correlation for allocating spectrum resources to a plurality of wireless devices according to an embodiment of the present disclosure, where the communication method may be implemented, for example, by the electronic device 1000 illustrated in FIG. 1.

As shown in FIG. 2, in S2000, the spectrum usage information acquiring unit 1020 acquires respective spectrum usage information of a plurality of wireless devices.

In some embodiments, the plurality of wireless devices may be a plurality of citizens Broadband Radio Service devices (CBSDs) in a Citizens Broadband Radio Service (CBRS) system. In other embodiments, the plurality of wireless devices may be a plurality of base stations in a 3rd Generation Partnership Project (3GPP) system. In addition, the wireless device described in the present disclosure is not limited to the CBSD and the base station described above, and may be other wireless devices that need to perform spectrum allocation.

In some embodiments, the spectrum usage information may include one or more of a device ID, a location, a usage frequency, a usage time of the usage frequency, a bandwidth, a transmit power, antenna information (which may include information of transmit/receive beams, for example) of the wireless device. The spectrum usage information may be current spectrum usage information of the wireless device or historical spectrum usage information of the wireless device. In addition, the spectrum usage information is not limited to the above example, and may be other information related to spectrum usage.

In S2010, the spectrum usage correlation determining unit 1030 determines spectrum usage correlation among the plurality of wireless devices based on the respective spectrum usage information of the plurality of wireless devices acquired by the spectrum usage information acquiring unit 1020 in S2000.

In some embodiments, the spectrum usage correlation include one or more of time correlation, position correlation, frequency correlation, power correlation, beam correlation. It should be appreciated that the spectrum usage correlation is not limited to the above examples, but may be other spectrum usage correlation among the plurality of wireless devices that affect spectrum allocation.

The spectrum usage correlation among the plurality of wireless devices determined according to the method illustrated in FIG. 2 may be used to allocate spectrum resources to the plurality of wireless devices, thereby improving the efficiency of dynamic spectrum allocation and reducing the overhead for interference computation.

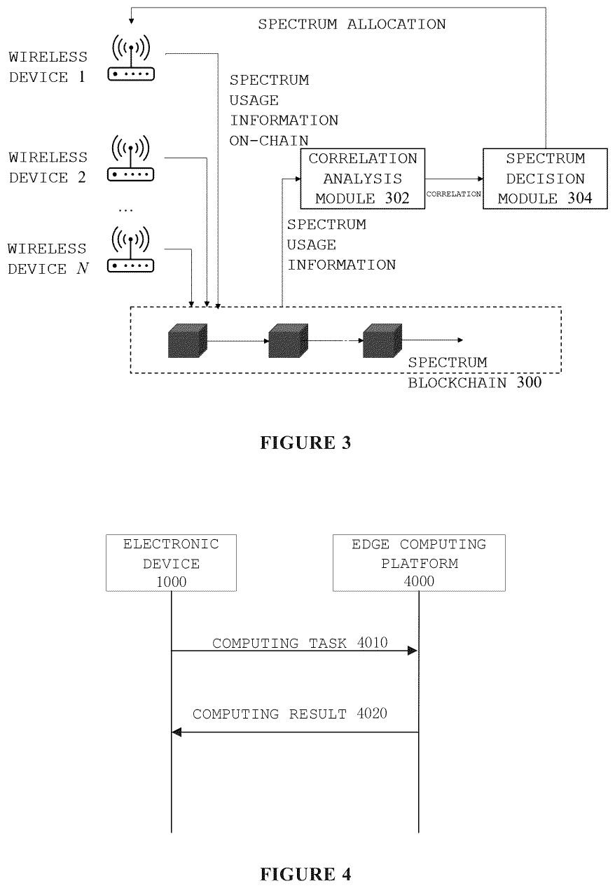

In some embodiments, spectrum blockchain may be established to obtain spectrum usage information in S2000. FIG. 3 is a schematic diagram illustrating the system in this case.

As shown in FIG. 3, spectrum blockchain 300 is established with a plurality of wireless devices 1, 2, . . . N, where each wireless device uploads its own spectrum usage information into the spectrum blockchain 300 and locally maintains a local ledger related to the spectrum usage information. An correlation analysis module 302 acquires stored spectrum usage information of the plurality of wireless devices from the spectrum blockchain 300, and determines spectrum usage correlation among the plurality of wireless devices based on the spectrum usage information. The correlation analysis module 302 may be configured in the electronic device 1000 described above, for example, and configured to implement the functions of the electronic device 1000. By establishing the spectrum blockchain, decentralization can be achieved, trust relationships among the plurality of wireless devices can be established, and single-point failure that may occur can be overcome. Additionally, it: should be understood that in some embodiments, instead of the spectrum blockchain 300, a storage device, such as cloud storage, may be employed to record and store spectrum usage information of the plurality of wireless devices.

In addition, the correlation analysis module 302 provides the determined spectrum usage correlation to a spectrum decision module 304. The spectrum decision module utilizes the spectrum usage correlation of the plurality of wireless devices 1, 2, . . . N to perform spectrum allocation to the plurality of wireless devices 1, 2, . . . N. The spectrum decision module 304 may be configured in the electronic device 1000, for example, together with the correlation analysis module 302, such that the electronic device 1000 implements both the determination of the spectrum usage correlation and the decision of the spectrum allocation. Additionally, the spectrum decision module 304 may also be configured separately from the correlation analysis module 302, such as deployed in a third party database operator, for performing spectrum allocation to the plurality of wireless devices based on the spectrum usage correlation among the plurality of wireless devices from the correlation analysis module 302.

In some embodiments, an artificial intelligence model may be utilized to determine spectrum usage correlation based on respective spectrum usage information of a plurality of wireless devices. The artificial intelligence model can be, for example, a neural network model including, but not limited to, a convolutional neural network CNN, a recurrent neural network RNN, a long-short term memory network LSTM, and the like.

In some embodiments, the artificial intelligence model may be trained, for example, using respective historical spectrum usage information of the plurality of wireless devices. Training algorithms may include a supervised learning algorithm, for example, that assists in supervised learning, by manually labeling the respective historical spectrum usage information of the plurality of wireless devices acquired by the spectrum usage information acquiring unit 1020. Additionally, the training algorithms may also include an unsupervised learning algorithm that is trained without prior information (e.g., the historical spectrum usage information of the wireless device). In addition, the training algorithms may also include a reinforcement learning algorithm, and the like. It should be understood that the training algorithms of the artificial intelligence model is not particularly limited by the present disclosure, and an appropriate training algorithm may be selected according to actual requirements.

In some embodiments, results obtained from the artificial intelligence model may be classified (e.g., Sigmoid processing) and spectrum usage correlation scores may be output. A value range of the spectrum usage correlation scores may be set to (0, 1), intervals of the spectrum usage correlation scores may be divided in advance, and a correlation result for any of the score intervals may be set. For example, the intervals (0, 0.2), [0.2, 0.5), [0.5, 0.8), [0.8, 1) of the spectrum usage correlation scores correspond to the spectrum usage correlation being uncorrelated, weakly correlated, secondarily correlated, primarily correlated, respectively. It should be understood that, the above classification and values of the spectrum usage correlation scores are only examples, and other classifications and values may be designed according to actual requirements.

In addition, in some embodiments, the artificial intelligence model may predict future spectrum usage correlation utilizing historical spectrum usage information, so that spectrum resources may be reserved in advance for future spectrum allocation, further improving the efficiency of £ spectrum allocation.

In some embodiments, the artificial intelligence model can be mounted in the electronic device 1000. Additionally, in view of high computing power requirements for the training process of the artificial intelligence model, in some embodiments, the artificial intelligence model can be trained on a computing platform separate from the electronic device 1000. For example, the electronic device 1000 may send a computing task for training to an edge computing platform (e.g., Multi-access Edge Computing (MEC) Platform), by which training of the artificial intelligence model is performed, and a trained computing result is sent to the electronic device 1000, so that the electronic device determines the spectrum usage correlation by using the artificial intelligence model. The edge computing platform may be provided by an operator or a third party cloud provider, for example.

By way of example, FIG. 4 illustrates a schematic diagram of computing task offloading according to an embodiment of the disclosure. As shown in FIG. 4, the electronic device 1000 sends a computing task 4010 for training to an edge computing platform 4000. The edge computing platform performs training of the artificial intelligence model according to the received computing task 4010, and sends a trained computing result 4020 (for example, a trained artificial intelligence model) to the electronic device 1000. Thus, the electronic device 1000 can utilize the artificial intelligence model to determine spectrum usage correlation, and computing requirements for the electronic device 1000 can be reduced.

It should be understood that, the above scheme of determining spectrum usage correlation based on the artificial intelligence model is merely an example, and in some embodiments, other statistical analysis methods may be used instead of the artificial intelligence model, to determine spectrum usage correlation among a plurality of wireless devices based on spectrum usage information of the plurality of wireless devices.

Next, the scheme of spectrum allocation based on spectrum usage correlation according to the present disclosure is specifically described. The spectrum usage correlation may include, for example, but is not limited to, one or more of time correlation, position correlation, frequency correlation, power correlation, beam correlation.

### Time correlation

Time correlation refers to correlation of a plurality of wireless devices using frequency resources over time. In some embodiments, in case where time correlation between a first wireless device (e.g., wireless device 1) and a second wireless device (e.g., wireless device 2) is less than a predetermined time correlation threshold, the first wireless device and the second wireless device may be allocated the same spectrum resources regardless of position correlation between the first wireless device and the second wireless device.

In some embodiments, the time correlation may be determined by a degree of overlap of historical usage time of frequencies by the wireless device 1 and the wireless device 2. For example, a degree of overlap of usage time of frequencies (not limited to the same frequency) by the wireless device 1 and the wireless device 2 over a period of time may be considered.

In case where the usage time of frequencies by the wireless device 1 and the wireless device 2 do not overlap for a period of time, it can be determined that the time at which the wireless device 1 and the wireless device 2 use frequency resources is not correlated. In this case, the same spectrum resources can be directly allocated to the wireless device 1 and the wireless device 2 at the time of the subsequent spectrum allocation, regardless of relative positions of the wireless device 1 and the wireless device 2 and without calculating mutual interference between the wireless device 1 and the wireless device 2. Thus, the efficiency of dynamic spectrum allocation can be improved and the overhead for interference calculation can be reduced.

In addition, in case where the usage time of the frequencies by the wireless device 1 and the wireless device 2 completely overlaps (i.e. the wireless device 1 and the wireless device 2 both have the requirement of using the frequencies) in the period of time, it may be determined that the time correlation of using the frequency resources by the wireless device 1 and the wireless device 2 is large, and correlation analysis in other aspects (such as position correlation, frequency correlation, etc.) may be continued to determine the spectrum allocation scheme.

In addition, in some embodiments, the time correlation threshold may be set according to actual conditions, for example, an overlap degree threshold 50% of the usage time is set as the time correlation threshold. When the degree of overlap of the usage time of frequencies by the wireless device 1 and the wireless device 2 is lower than the overlap degree threshold 50%, the time correlation between the wireless device 1 and the wireless device 2 is considered to be small, so that the same spectrum resources can be allocated to the wireless device 1 and the wireless device 2 regardless of the position correlation between the wireless device 1 and the wireless device 2.

In addition, the time correlation may also be determined using the artificial intelligence model-based approach described above. For example, historical spectrum usage information (e.g., device ID, usage frequency, usage time of usage frequency, etc.) of the wireless device 1 and the wireless device 2 may be input into the artificial intelligence model, and time correlation scores and corresponding classification results (e.g., one of uncorrelated, weakly correlated, secondarily correlated, primarily correlated) may be obtained as outputs. In case where the time correlation between the wireless device 1 and the wireless device 2 is weakly correlated or less (i.e., weakly correlated or uncorrelated) (at the time, the time correlation threshold may correspond to weakly correlated), it is considered that the time correlation between the wireless device 1 and the wireless device 2 is small, so that the same spectrum resources can be allocated to the wireless device 1 and the wireless device 2 regardless of the position correlation between the wireless device 1 and the wireless device 2.

### Position Correlation

Position correlation refers to whether relative positions of a plurality of wireless devices interfere with each other for the use of the same or similar frequency resources, and the more likely the interference, the higher the position correlation. In some embodiments, in case where position correlation between a first wireless device (e.g., wireless device 1) and a second wireless device (e.g., wireless device 2) is less than a predetermined position correlation threshold, the first wireless device and the second wireless device may be allocated the same spectrum resources regardless of time correlation between the first wireless device and the second wireless device.

The position correlation may be determined, for example, by a distance between two wireless devices and a channel propagation model (e.g., path loss), where higher position correlation indicates greater interference generated by the two wireless devices when using the same or similar frequencies in the same period of time, and lower position correlation indicates less interference generated by the two wireless devices when using the same or similar frequencies in the same period of time.

In some embodiments, the position correlation threshold may be set according to actual conditions and compared with the position correlation determined based on a distance and a channel propagation model between the wireless device 1 and the wireless device 2, and when the position correlation is less than the position correlation threshold (for example, the wireless device 2 is located outside an exclusive area of the wireless device 1), it may be considered that interference possibly generated between the two wireless devices is small, and therefore, the same spectrum resources may be allocated to the wireless device 1 and the wireless device 2 regardless of whether the spectrum resources are used by the wireless device 1 and the wireless device 2 at the same time. this can reduce the overhead for interference calculation and enables efficient spectrum allocation.

In some embodiments, the artificial intelligence model-based approach described above may also be utilized to determine the position correlation. For example, historical spectrum usage information (e.g., device ID, location, transmit power, etc.) of the wireless device 1 and the wireless device 2 may be input into the artificial intelligence model, and position correlation scores and corresponding classification results (e. g., one of uncorrelated, weakly correlated, secondarily correlated, primarily correlated) may be obtained as outputs. In case where the position correlation between the wireless device 1 and the wireless device 2 is weakly correlated or less (i.e., weakly correlated or uncorrelated) (at the time, the position correlation threshold may correspond to weakly correlated), the position correlation between the wireless device 1 and the wireless device 2 is considered to be small, so that the same spectrum resources can be allocated to the wireless device 1 and the wireless device 2 regardless of the time correlation between the wireless device 1 and the wireless device 2.

### Frequency Correlation

Frequency correlation refers to correlation of frequency resources used by a plurality of wireless devices. In some embodiments, in case where frequency correlation between a first wireless device (e.g., wireless device 1) and a second wireless device (e.g., wireless device 2) is higher than a predetermined frequency correlation threshold, the same spectrum resources may be allocated to the first wireless device and the second wireless device regardless of time correlation and position correlation between the first wireless device and the second wireless device.

Considering that there is a certain regularity in service and spectrum usage of the wireless devices, according to historical spectrum allocation information, if spectrums allocated to the wireless device 1 and the wireless device 2 in the past have high correlation, for example, the same spectrum resources are often used, it can be said that there is a high probability that the wireless device 1 and the wireless device 2 will not interfere with each other, and the same spectrum can be directly allocated at the next spectrum allocation without an Iterative Allocation Process (IAP) for interference calculation again. Thus, the efficiency of dynamic spectrum allocation can be improved and the overhead for interference calculation can be reduced.

In some embodiments, the frequency correlation may be determined from historical spectrum allocation information of the wireless device 1 and the wireless device 2. For example, in case where same-frequency interference is considered, it may be analyzed whether or not spectrums used by the wireless device 1 and the wireless device 2 in a past period of time are the same or partially the same, and frequency correlation may be determined according to similarity of the spectrums. For example, the more similar the spectrums, the higher the frequency correlation. In addition, in case adjacent-frequency interference is considered in addition to same-frequency interference, it may be analyzed whether the spectrums and adjacent spectrums used by the wireless device 1 and the wireless device 2 in the past period of time are the same or partially the same, and frequency correlation may be determined based on this.

In some embodiments, a frequency correlation threshold may be set according to actual conditions and compared with the determined frequency correlation between the wireless device 1 and the wireless device 2, and when the frequency correlation is higher than the frequency correlation threshold, it may be considered that the spectrums used by the two wireless devices in the past have high similarity, so that the two wireless devices may not interfere with each other with a high probability, and therefore, the same frequency spectrum resources may be allocated to the wireless device 1 and the wireless device 2 regardless of the time correlation and the position correlation between the two wireless devices. Thus, the efficiency of dynamic spectrum allocation can be improved and the overhead for interference calculation can be reduced.

Additionally, in some embodiments, the frequency correlation may also be determined using the artificial intelligence model-based approach described above. For example, historical spectrum usage information (e.g., device ID, usage frequency) of the wireless device 1 and the wireless device 2 may be input into the artificial intelligence model and frequency correlation scores and corresponding classification results (e.g., one of uncorrelated, weakly correlated, secondarily correlated, primarily correlated) may be obtained as outputs. In case where the frequency correlation between the wireless device 1 and the wireless device 2 is secondarily correlated or more (i.e., secondarily correlated or primarily correlated) (at the time, the frequency correlation threshold may correspond to secondarily correlated), the frequency correlation between the wireless device 1 and the wireless device 2 is considered to be large, so that the same spectrum resources can be allocated to the wireless device 1 and the wireless device 2 regardless of the time correlation and position correlation between the wireless device 1 and the wireless device 2.

### Power Correlation

Power correlation refers to correlation of a plurality of wireless devices in power allocation. In some embodiments, in case where power correlation between a first wireless device (e. g., wireless device 1) and a second wireless device (e.g., wireless device 2) is greater than a predetermined power correlation threshold, the second wireless device may be power allocated according to power allocation of the first wireless device.

In some embodiments, the power correlation may be determined based on similarity of values or similarity of trends in changes of historically allocated power (e. g., maximum transmit power) for the wireless device 1 and the wireless device 2. The more similar the values or trends in changes of power, the greater the power correlation between the wireless device 1 and the wireless device 2. For the calculation of similarity of the values or trends in changes of power, it is not particularly limited in the present disclosure, and any appropriate manner may be adopted, such as calculating a difference between the historically allocated power values for the wireless device 1 and the wireless device 2, or linearly fitting the trends in changes of the historically allocated power for the wireless device 1 and the wireless device 2 and calculating a similarity of the fitted curve, or calculating the similarity of the values or trends in changes of power in other manners.

In some embodiments, a power correlation threshold may be set according to actual conditions and compared with the determined power correlation between the wireless device 1 and the wireless device 2, and when the power correlation is higher than the power correlation threshold, the past allocated power for the two wireless devices may be considered to have high similarity, so that the wireless device 2 may be power allocated using the power allocation of the wireless device 1, and vice versa. This can improve the efficiency of power allocation.

Additionally, in some embodiments, the power correlation may also be determined using the artificial intelligence model-based approach described above. For example, historical spectrum usage information (e.g., device ID, bandwidth, transmit power, etc.) of the wireless device 1 and the wireless device 2 may be input into the artificial intelligence model and power correlation scores and corresponding classification results (e.g., one of uncorrelated, weakly correlated, secondarily correlated, primarily correlated) may be obtained as outputs. In case where the power correlation between the wireless device 1 and the wireless device 2 is secondarily correlated or more (i. e. secondarily correlated or primarily correlated) (at the time, the power correlation threshold may correspond to secondarily correlated), the power correlation between the wireless device 1 and the wireless device 2 is considered to be large, so that the wireless device 2 may be power allocated using the power allocation of the wireless device 1, and vice versa.

### Beam Correlation

Beam correlation refers to correlation of transmit/receive beams used by a plurality of wireless devices. In some embodiments, in case where beam correlation between a first wireless device (e. g., wireless device 1) and a second wireless device (e. g., wireless device 2) is less than a predetermined beam correlation threshold, the same spectrum resources may be allocated to the first wireless device and the second wireless device regardless of time correlation and position correlation between the first wireless device and the second wireless device.

The beam correlation may be determined, for example, based on historically used beams by the wireless device 1 and the wireless device 2. For example, in case where the wireless device 1 and the wireless device 2 use beams in different directions, the beam correlation between the wireless device 1 and the wireless device 2 may be considered to be low, while in case where the wireless device 1 and the wireless device 2 use beams in the same direction, the beam correlation between the wireless device 1 and the wireless device 2 may be considered to be high.

In some embodiments, a beam correlation threshold may be set according to actual conditions and compared with the determined beam correlation between the wireless device 1 and the wireless device 2, and when the beam correlation is less than the beam correlation threshold, the beams used by the two wireless devices may be considered to be incoherent, so that the same spectrum resources may be allocated to the corresponding beams. This can improve the spectrum efficiency.

Additionally, in some embodiments, the beam correlation may also be determined by utilizing the artificial intelligence model-based approach described above. For example, historical spectrum usage information (e.g., device ID, antenna information, etc.) of the wireless device 1 and the wireless device 2 may be input into the artificial intelligence model and beam correlation scores and corresponding classification results (e.g., one of uncorrelated, weakly correlated, secondarily correlated, primarily correlated) may be obtained as outputs. In case where the beam correlation between the wireless device 1 and the wireless device 2 is weakly correlated or less (i.e., weakly correlated or uncorrelated) (at the time, the beam correlation threshold may correspond to weakly correlated), it is considered that the beam correlation between the wireless device 1 and the wireless device 2 is small, so that the same spectrum resources can be allocated to the wireless device 1 and the wireless device 2 regardless of the time correlation and position correlation between the wireless device 1 and the wireless device 2.

Specific examples of spectrum allocation based on spectrum usage correlation according to the present disclosure are described above. It should be appreciated that the spectrum usage correlation is not limited to the above examples, and may be other spectrum usage correlation among a plurality of wireless devices affecting spectrum allocation, and the spectrum allocation may be performed based on other spectrum usage correlation.

In some embodiments, wireless devices capable of allocating the same spectrum resources may be grouped into the same group for unified management. In addition, for different correlation (time correlation, position correlation, frequency correlation, power correlation, beam correlation, etc.), the wireless devices can be further divided into subgroups for each type of correlation, thereby performing more refined management and improving spectrum allocation efficiency.

The above describes a manner of spectrum resource allocation based on spectrum correlation, for each type of spectrum usage correlation. In some embodiments, spectrum resource allocation may also be performed by taking into account two or more types of spectrum usage correlation.

In particular, in some embodiments, the spectrum usage correlation may include spectrum usage integrated correlation, which is calculated by assigning weights to two or more of time correlation, position correlation, frequency correlation, power correlation, and beam correlation.

For example, the spectrum usage integrated correlation may be calculated by assigning weights to the time correlation and the position correlation. The weights may be determined according to specific situations of the network, for example, in case where the time correlation needs more considerations, the time correlation may be assigned a larger weight, and in case where the position correlation needs more considerations, the position correlation may be assigned a larger weight. In addition, other types of spectrum correlation may be selected and assigned weights to calculate the spectrum usage integrated correlation, according to a focus on the spectrum correlation.

In some embodiments, in case where the spectrum usage integrated correlation of the wireless device 1 and the wireless device 2 is less than a predetermined integrated correlation threshold, the integrated correlation of the wireless device 1 and the wireless device 2 may be considered to be low, so that the same spectrum resources may be directly allocated to the wireless device 1 and the wireless device 2, without considering each spectrum correlation separately and without considering other types of spectrum correlation not included in the integrated correlation. The spectrum allocation based on the integrated correlation may also be referred to as spectrum coarse allocation.

In some embodiments, in case where the spectrum usage integrated correlation of the wireless device 1 and the wireless device 2 is higher than the predetermined integrated correlation threshold, it may be considered that the two wireless devices are determined to have higher spectrum correlation in case of spectrum coarse allocation, so that two or more types of correlation included in the integrated correlation need to be further determined separately. For example, in case where the spectrum usage integrated correlation is calculated by assigning weights to the time correlation and the position correlation, the time correlation and the position correlation between the wireless device 1 and the wireless device 2 may be further determined, respectively, and spectrum resource allocation may be performed accordingly. This allocation may also be referred to as spectral fine allocation.

By determining the spectrum usage integrated correlation and performing spectrum coarse allocation, and performing spectrum fine allocation as appropriate, the spectrum allocation efficiency can be further improved.

In some embodiments, as described above, the artificial intelligence model may be trained for each type of spectrum usage correlation, so as to obtain an artificial intelligence model for each type of spectrum usage correlation, and a corresponding spectrum usage correlation score may be obtained by using the corresponding artificial. intelligence model, and a result of spectrum usage correlation is determined according to a scoring interval corresponding to the spectrum usage correlation score. In other embodiments, two or more types of spectrum usage correlation may be selected and respectively set with weights, and the artificial intelligence model is accordingly comprehensively trained, so as to obtain an artificial intelligence model for the spectrum usage integrated correlation, thereby obtaining the spectrum usage integrated correlation of a plurality of wireless devices.

In some embodiments, the weights may be obtained from a wireless device operator (e.g., a wireless device operator network administrator) or may be given by the electronic device 1000 itself.

Next, a specific application example of spectrum resource allocation according to an embodiment of the present disclosure is described.

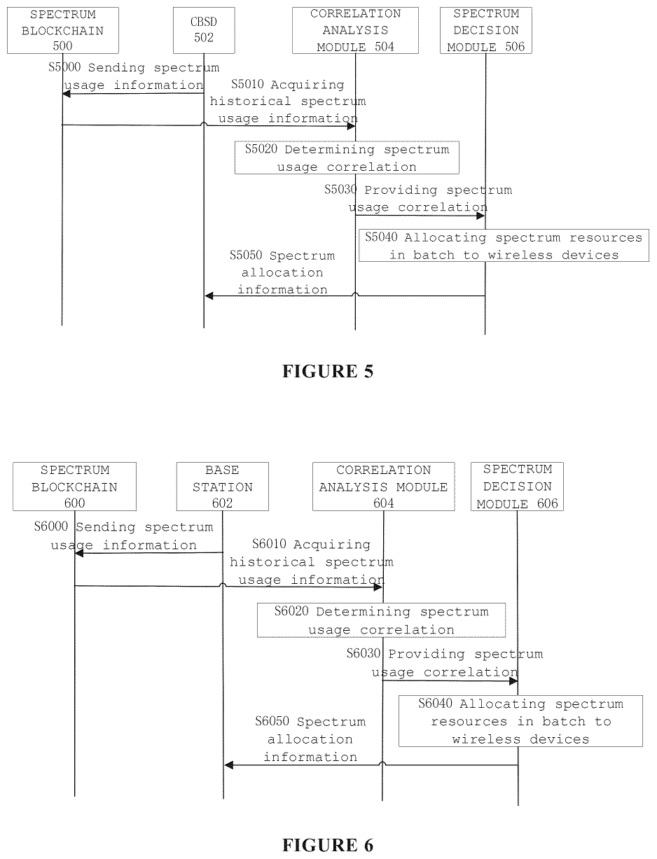

FIG. 5 is a schematic diagram illustrating application of spectrum resource allocation to a CBRS system according to an embodiment of the present disclosure.

As shown in FIG. 5, in S5000, CBSD 502 transmits and records spectrum usage information into a spectrum block chain 500. The spectrum blockchain 500 may be composed of a plurality of CBSDs, each CBSD uploading its own spectrum usage information into the spectrum blockchain 300 and locally maintaining a local ledger related to the spectrum usage information. In addition, the spectrum blockchain 500 may be formed in a distributed manner by spectrum management apparatuses equipped with correlation analysis modules 504.

In S5010, the correlation analysis module 504 acquires historical spectrum usage information of a plurality of CBSDs from the spectrum blockchain 500 in S5010, and determines spectrum usage correlation using the acquired spectrum usage information in S5020 (e.g., learning using an artificial intelligence model). The correlation analysis module 504 may correspond to the correlation analysis module 302 described in FIG. 3, and may be installed in the electronic device 1000 described in FIG. 1. In addition, the correlation analysis module 504 (or the electronic device 1000 installed thereon) may be provided in a Spectrum Access System (SAS) or a Coexistence Manager (CxM) of the CBRS System, and may be implemented by, for example, an artificial intelligence function module of the SAS/CxM. For example, the artificial intelligence function module of the SAS/CxM may obtain historical spectrum usage information from the spectrum blockchain 500, and analyze spectral correlation of the spectrum resources used by the respective CBSDs 502.

In some embodiments, the correlation analysis module 504 may generate different artificial intelligence models for different entries of the spectrum usage information, respectively (e.g., a separate artificial intelligence model for each spectrum usage correlation), and perform real-time statistics on the accuracy of the artificial intelligence models (e.g., compare the spectrum usage correlation predicted by the artificial intelligence model to an actual spectrum usage correlation). In addition, the correlation analysis module 504 can offload computing tasks to a computing platform in a network (e.g., the edge computing platform 4000 shown in FIG. 4) for centralized completion.

In S5030, the correlation analysis module 504 provides the determined spectrum usage correlation to a spectrum decision module 506.

In S5040, the spectrum decision module 506 may group the plurality of CBSDs 502 according to the spectrum usage correlation information and perform spectrum allocation in batch to the plurality of CBSDs 502 according to available spectrum resource data.

In S5050, the spectrum decision module 506 sends spectrum allocation information to respective CBSDs 502.

By applying the spectrum resource allocation of the present disclosure to the CBRS system, the spectrum allocation efficiency of the CBRS system can be improved and the overhead for interference calculation can be reduced.

FIG. 6 is a schematic diagram illustrating application of spectrum resource allocation to a 3GPP system according to an embodiment of the present disclosure.

As shown in FIG. 6, in S6000, a base station 602 transmits and records spectrum usage information into a spectrum blockchain 600. The spectrum blockchain 600 may be composed of base stations of multiple co-constructed shared operators, and each base station uploads its own spectrum usage information to the spectrum blockchain 600 and locally maintains a local ledger related to the spectrum usage information. In addition, the spectrum blockchain 600 may be also formed in a distributed manner by spectrum management apparatuses equipped with correlation analysis modules 604.

In S6010, the correlation analysis module 604 acquires historical spectrum usage information of the plurality of base stations 602 from the spectrum blockchain in S6010, and determines spectrum usage correlation using the acquired spectrum usage information in S6020 (e.g., learning using an artificial intelligence model). The correlation analysis module 604 may correspond to the correlation analysis module 302 described in FIG. 3, and may be installed in the electronic device 1000 described in FIG. 1. In addition, the correlation analysis module 604 (or the electronic device 1000 installed thereon) may be implemented by a Network Data Analytics Function (NWDAF) module of the 3GPP core Network. For example, the NWDAF module may obtain historical spectrum usage information from the spectrum blockchain 600 and analyze frequency correlation of the spectrum resources used by respective base stations 602.

In some embodiments, the correlation analysis module 604 may generate different artificial intelligence models for different entries of spectrum usage information, respectively (e.g., a separate artificial intelligence model for each spectrum usage correlation), and perform real-time statistics on the accuracy of the artificial intelligence models (e.g., compare the spectrum usage correlation predicted by the artificial intelligence model to an actual spectrum usage correlation). In addition, the correlation analysis module 604 can offload computing tasks to a computing platform in a network (e.g., the edge computing platform 4000 shown in FIG. 4) for centralized completion.

In S6030, the correlation analysis module 604 provides the determined spectrum usage correlation to a spectrum decision module 606.

In S6040, the spectrum decision module 606 may group the plurality of base stations 602 according to the spectrum usage correlation information, and perform spectrum allocation in batch to the plurality of base stations 602 according to available spectrum resource data.

In S6050, the spectrum decision module 606 sends the spectrum allocation information to respective base stations 502.

By applying the spectrum resource allocation of the present disclosure to the 3GPP system, the spectrum allocation efficiency of the 3GPP system can be improved and the overhead for interference calculation can be reduced.

It should be appreciated that, reference throughout this specification to “an embodiment” or the like means that a particular feature, structure, or characteristic described in connection with the embodiment is included in at least one specific embodiment of the present disclosure. Thus, appearances of the phrases “in an embodiment of the present disclosure” and the like throughout this specification do not necessarily refer to the same embodiment.

One skilled in the art will appreciate that, the present disclosure may be implemented as a system, apparatus, method, or computer-readable storage medium (e.g., non-transitory storage medium) as a computer program product. Accordingly, the present disclosure may be embodied in various forms, such as an entirely hardware embodiment, an entirely software embodiment (including firmware, resident software, micro-program I code, etc.) or an embodiment combining software and hardware, which may be referred to hereinafter as a “circuit”, “module” or “system”. Furthermore, the present disclosure may also be implemented in any tangible media form as a computer program product, having computer usable program code stored thereon.

The description of the present disclosure is described with reference to flow and/or block diagrams of the system, apparatus, method and computer program product according to the embodiments of the disclosure. It will be understood that each block of the flow and/or block diagrams, and any combination of blocks in the flow and/or block diagrams, can be implemented by computer program instructions. These computer program instructions may be executed by a machine formed by a processor of a general purpose computer or special purpose computer, or other programmable data processing apparatuses, and the instructions are processed by the computer or other programmable data processing apparatuses, to implement the functions or operations specified in the flow and/or block diagrams.

The architecture, functionality, and operations that may be implemented by the system, method and computer program product according to various embodiments of the present disclosure are illustrated in the accompanying drawings as flow and block diagrams. Accordingly, each block in the flow or block diagrams may represent a module, segment, or portion of program code, which comprises one or more executable instructions for implementing the specified logical function(s). It should also be noted that, in some alternative embodiments, the functions noted in the blocks may occur out of the order noted in the figures. For example, two blocks shown in succession may, in fact, be executed substantially concurrently, or may sometimes be executed in a reverse order, depending upon the functionality involved. It will also be noted that each block in the block and/or flow diagrams, and combinations of blocks in the block and/or flow diagrams, can be implemented by special purpose hardware-based systems, or specified functions or operations can be performed by combinations of special purpose hardware and computer instructions.

The foregoing has described the embodiments of the present disclosure, but it is illustrative but not exhaustive, and is not limited to the embodiments disclosed. Many modifications and variations will be apparent to those of ordinary skill in the art without departing from the scope and spirit of the described embodiments. The terms used herein are chosen in order to best explain the principles of the embodiments, the practical application, or technical improvements to the market, or to enable others of ordinary skill in the art to understand the embodiments disclosed herein.

Note that the technique disclosed in this specification may have the following configuration.
(1) An electronic device, comprising:
processing circuitry configured to:
acquire respective spectrum usage information of a plurality of wireless devices; and
determine spectrum usage correlation among the plurality of wireless devices based on the respective spectrum usage information of the plurality of wireless devices, the spectrum usage correlation being used for allocating spectrum resources to the plurality of wireless devices.
(2) The electronic device according to (1), wherein,
the spectrum usage information comprises one or more of a device ID, location, usage frequency, usage time of the usage frequency, bandwidth, transmit power, antenna information of the wireless device,
the spectrum usage correlation comprises one or more of time correlation, position correlation, frequency correlation, power correlation, beam correlation.
(3) The electronic device according to (2), wherein, in case where time correlation between a first wireless device and a second wireless device is less than a predetermined time correlation threshold, the same spectrum resources are allocated to the first wireless device and the second wireless device regardless of position correlation between the first wireless device and the second wireless device.
(4) The electronic device according to (2), wherein,
in case where position correlation between a first wireless device and a second wireless device is less than a predetermined position correlation threshold, the same spectrum resources are allocated to the first wireless device and the second wireless device regardless of time correlation between the first wireless device and the second wireless device.
(5) The electronic device according to (2), wherein,
in case where frequency correlation between a first wireless device and a second wireless device is greater than a predetermined frequency correlation threshold, the same spectrum resources are allocated to the first wireless device and the second wireless device regardless of time correlation and position correlation between the first wireless device and the second wireless device.
(6) The electronic device according to (2), wherein,
in case where power correlation between a first wireless device and a second wireless device is higher than a predetermined power correlation threshold, the second wireless device is power allocated according to power allocation of the first wireless device.
(7) The electronic device according to (2), wherein,
in case where beam correlation between a first wireless device and a second wireless device is less than a predetermined beam correlation threshold, the same spectrum resources are allocated to the first wireless device and the second wireless device regardless of time correlation and position correlation between the first wireless device and the second wireless device.
(8) The electronic device according to (2), wherein,
the spectrum usage correlation comprises spectrum usage integrated correlation, which is calculated by assigning weights to two or more of the time correlation, the position correlation, the frequency correlation, the power correlation, and the beam correlation.
(9) The electronic device according to (2), wherein, the weights are acquired from a wireless device operator or determined by the electronic device.
(10) The electronic device according to (8), wherein,
in case where spectrum usage integrated correlation between a first wireless device and a second wireless device is greater than a predetermined integrated correlation threshold, the two or more correlation between the first wireless device and the second wireless device are determined respectively.
(11) The electronic device according to (1), wherein,
the spectrum usage information is acquired from a spectrum blockchain established by the plurality of wireless devices.
(12) The electronic device according to (1), wherein,
the spectrum usage correlation among the plurality of wireless devices is determined based on the respective spectrum usage information of the plurality of wireless devices, using an artificial intelligence model which is trained using respective historical spectrum usage information of the plurality of wireless devices.
(13) The electronic device according to (12), wherein,
the artificial intelligence model is trained on a computing platform independent of the electronic device.
(14) A communication method, comprising:
acquiring respective spectrum usage information of a plurality of wireless devices; and
determining spectrum usage correlation among the plurality of wireless devices based on the respective spectrum usage information of the plurality of wireless devices, the spectrum usage correlation being used for allocating spectrum resources to the plurality of wireless devices.
(15) The communication method according to (14), wherein,
the spectrum usage information comprises one or more of a device ID, location, usage frequency, usage time of the usage frequency, bandwidth, transmit power, antenna information of the wireless device,
the spectrum usage correlation comprises one or more of time correlation, position correlation, frequency correlation, power correlation, beam correlation.
(16) The communication method according to (15), wherein,
in case where time correlation between a first wireless device and a second wireless device is less than a predetermined time correlation threshold, the same spectrum resources are allocated to the first wireless device and the second wireless device regardless of position correlation between the first wireless device and the second wireless device.
(17) The communication method according to (15), wherein, in case where position correlation between a first wireless device and a second wireless device is less than a predetermined position correlation threshold, the same spectrum resources are allocated to the first wireless device and the second wireless device regardless of time correlation between the first wireless device and the second wireless device.
(18) The communication method according to (15), wherein,
in case where frequency correlation between a first wireless device and a second wireless device is greater than a predetermined frequency correlation threshold, the same spectrum resources are allocated to the first wireless device and the second wireless device regardless of time correlation and position correlation between the first wireless device and the second wireless device.
(19) The communication method according to (15), wherein,
in case where power correlation between a first wireless device and a second wireless device is higher than a predetermined power correlation threshold, the second wireless device is power allocated according to power allocation of the first wireless device.
(20) The communication method according to (15), wherein,
in case where beam correlation between a first wireless device and a second wireless device is less than a predetermined beam correlation threshold, the same spectrum resources are allocated to the first wireless device and the second wireless device regardless of time correlation and position correlation between the first wireless device and the second wireless device.
(21) The communication method according to (15), wherein,
the spectrum usage correlation comprises spectrum usage integrated correlation, which is calculated by assigning weights to two or more of the time correlation, the position correlation, the frequency correlation, the power correlation, and the beam correlation.
(22) The communication method according to (15), wherein, the weights are acquired from a wireless device operator or determined by an electronic device performing the communication method.
(23) The communication method according to (15), wherein,
in case where spectrum usage integrated correlation between a first wireless device and a second wireless device is greater than a predetermined integrated correlation threshold, the two or more correlation between the first wireless device and the second wireless device are determined respectively.
(24) The communication method according to (14), wherein,
the spectrum usage information is acquired from a spectrum blockchain established by the plurality of wireless devices.
(25) The communication method according to (14), wherein,
the spectrum usage correlation among the plurality of wireless devices is determined based on the respective spectrum usage information of the plurality of wireless devices, using an artificial intelligence model which is trained using respective historical spectrum usage information of the plurality of wireless
(26) A computer-readable storage medium comprising executable instructions which, when executed by an information processing apparatus, cause the information processing apparatus to perform the communication method according to any one of (14) to (25).
(27) A computer program product comprising a computer program which, when executed by a processor, causes the processor to perform the communication method according to any one of (14) to (25).

1. An electronic device, comprising:
processing circuitry configured to:
acquire respective spectrum usage information of a plurality of wireless devices; and
determine spectrum usage correlation among the plurality of wireless devices based on the respective spectrum usage information of the plurality of wireless devices, the spectrum usage correlation being used for allocating spectrum resources to the plurality of wireless devices.

2. The electronic device according to claim 1, wherein,
the spectrum usage information comprises one or more of a device ID, location, usage frequency, usage time of the usage frequency, bandwidth, transmit power, antenna information of the wireless device,
the spectrum usage correlation comprises one or more of time correlation, position correlation, frequency correlation, power correlation, beam correlation.

3. The electronic device according to claim 2, wherein,
in case where time correlation between a first wireless device and a second wireless device is less than a predetermined time correlation threshold, the same spectrum resources are allocated to the first wireless device and the second wireless device regardless of position correlation between the first wireless device and the second wireless device; and/or
in case where position correlation between a first wireless device and a second wireless device is less than a predetermined position correlation threshold, the same spectrum resources are allocated to the first wireless device and the second wireless device regardless of time correlation between the first wireless device and the second wireless device: and/or
in case where frequency correlation between a first wireless device and a second wireless device is greater than a predetermined frequency correlation threshold, the same spectrum resources are allocated to the first wireless device and the second wireless device regardless of time correlation and position correlation between the first wireless device and the second wireless device; and/or
in case where power correlation between a first wireless device and a second wireless device is higher than a predetermined power correlation threshold, the second wireless device is power allocated according to power allocation of the first wireless device.

4.-6. (canceled)

7. The electronic device according to claim 2, wherein,
in case where beam correlation between a first wireless device and a second wireless device is less than a predetermined beam correlation threshold, the same spectrum resources are allocated to the first wireless device and the second wireless device regardless of time correlation and position correlation between the first wireless device and the second wireless device.

8. The electronic device according to claim 2, wherein,
the spectrum usage correlation comprises spectrum usage integrated correlation, which is calculated by assigning weights to two or more of the time correlation, the position correlation, the frequency correlation, the power correlation, and the beam correlation.

9. The electronic device according to claim 8, wherein, the weights are acquired from a wireless device operator or determined by the electronic device.

10. The electronic device according to claim 8, wherein,
in case where spectrum usage integrated correlation between a first wireless device and a second wireless device is greater than a predetermined integrated correlation threshold, the two or more correlation between the first wireless device and the second wireless device are determined respectively.

11. The electronic device according to claim 1, wherein,
the spectrum usage information is acquired from a spectrum blockchain established by the plurality of wireless devices.

12. The electronic device according to claim 1, wherein,
the spectrum usage correlation among the plurality of wireless devices is determined based on the respective spectrum usage information of the plurality of wireless devices, using an artificial intelligence model which is trained using respective historical spectrum usage information of the plurality of wireless devices.

13. The electronic device according to claim 12, wherein,
the artificial intelligence model is trained on a computing platform independent of the electronic device.

14. A communication method, comprising:
acquiring respective spectrum usage information of a plurality of wireless devices; and
determining spectrum usage correlation among the plurality of wireless devices based on the respective spectrum usage information of the plurality of wireless devices, the spectrum usage correlation being used for allocating spectrum resources to the plurality of wireless devices.

15. The communication method according to claim 14, wherein,
the spectrum usage information comprises one or more of a device ID, location, usage frequency, usage time of the usage frequency, bandwidth, transmit power, antenna information of the wireless device,
the spectrum usage correlation comprises one or more of time correlation, position correlation, frequency correlation, power correlation, beam correlation.

16. The communication method according to claim 15, wherein,
in case where time correlation between a first wireless device and a second wireless device is less than a predetermined time correlation threshold, the same spectrum resources are allocated to the first wireless device and the second wireless device regardless of position correlation between the first wireless device and the second wireless device; and/or
in case where position correlation between a first wireless device and a second wireless device is less than a predetermined position correlation threshold, the same spectrum resources are allocated to the first wireless device and the second wireless device regardless of time correlation between the first wireless device and the second wireless device; and/or
in case where frequency correlation between a first wireless device and a second wireless device is greater than a predetermined frequency correlation threshold, the same spectrum resources are allocated to the first wireless device and the second wireless device regardless of time correlation and position correlation between the first wireless device and the second wireless device; and/or
in case where power correlation between a first wireless device and a second wireless device is higher than a predetermined power correlation threshold, the second wireless device is power allocated according to power allocation of the first wireless device.

17.-19. (canceled)

20. The communication method according to claim 15, wherein,
in case where beam correlation between a first wireless device and a second wireless device is less than a predetermined beam correlation threshold, the same spectrum resources are allocated to the first wireless device and the second wireless device regardless of time correlation and position correlation between the first wireless device and the second wireless device.

21. The communication method according to claim 15, wherein,
the spectrum usage correlation comprises spectrum usage integrated correlation, which is calculated by assigning weights to two or more of the time correlation, the position correlation, the frequency correlation, the power correlation, and the beam correlation.

22. The communication method according to claim 15, wherein, the weights are acquired from a wireless device operator or determined by an electronic device performing the communication method.

23. The communication method according to claim 14, wherein,
in case where spectrum usage integrated correlation between a first wireless device and a second wireless device is greater than a predetermined integrated correlation threshold, the two or more correlation between the first wireless device and the second wireless device are determined respectively.

24. The communication method according to claim 14, wherein,
the spectrum usage information is acquired from a spectrum blockchain established by the plurality of wireless devices.

25. The communication method according to claim 14, wherein,
the spectrum usage correlation among the plurality of wireless devices is determined based on the respective spectrum usage information of the plurality of wireless devices, using an artificial intelligence model which is trained using respective historical spectrum usage information of the plurality of wireless devices.

26. (canceled)

27. A computer program product comprising a computer program which, when executed by a processor, causes the processor to perform a communication method comprising the following steps:
acquiring respective spectrum usage information of a plurality of wireless devices; and
determining spectrum usage correlation among the plurality of wireless devices based on the respective spectrum usage information of the plurality of wireless devices. the spectrum usage correlation being used for allocating spectrum resources to the plurality of wireless devices.
